(19) United States
(12) Patent Application Publication
(10) Pub. No.: US 2009/0070509 A1
(43) Pub. Date: Mar. 12, 2009

(54) Method of detecting and protecting falling portable computer hard disk through software monitoring driver

(76) Inventor: Chai-Chang Chlu, Tucheng City (TW)

Correspondence Address: QUINTERO LAW OFFICE, PC, 2210 MAIN STREET, SUITE 200, SANTA MONICA, CA, 90405, US

(21) Appl. No.: 11/898,084

(22) Filed: Sep. 10, 2007

(51) Int. Cl. G06F 13/24

(52) U.S. Cl. 710/266; 710/260

(57) ABSTRACT

In a method of detecting and protecting a hard disk of a falling portable computer, a falling sensor detects a falling state of a portable computer and sends an interrupt signal to a keyboard controller of the computer, and a falling state signal is responded at a default signal port of the keyboard controller. A software monitoring driver executes polling via an I/O driver about the falling state signal at the default signal port of the keyboard controller, and determines based on the falling state signal whether to actuate a hard disk protection mechanism, in which the software monitoring driver interrupts hard disk data access on the computer via a hard disk driver, and causes a system BIOS of the computer to send a parking control signal to the hard disk.

### FIELD OF THE INVENTION

The present invention relates to a technique for protecting portable computer hard disk, and more particularly to a method of detecting and protecting falling a hard disk of a portable computer through a software monitoring driver.

### BACKGROUND OF THE INVENTION

Computer apparatus have been widely employed in factories, business offices, and homes. With the use or the help of computer apparatus, it is possible to obtain the highest working efficiency, the optimal advertising effect, and the most convenient living conditions. Particularly, in recent years, the popularization of portable or notebook computer has brought even increased conveniences to users.

However, the portable or notebook computer is subject to undesirable falling due to poor working environment, user's negligence, or improper use of the computer, that would adversely affect the normal operation of the portable computer and result in damage of the precision devices mounted therein, including the hard disk thereof, and data in the damaged hard disk would be destroyed. To protect the hard disk of a portable computer from damage in falling or violent vibration, some portable computers are incorporated with a falling sensor.

There are various techniques of prior art for detecting and protecting a computer from possible damage to the hard disk at careless falling. For example, Taiwan Utility Model No. M298215 discloses a storage device with power failure protection. The storage device includes a sensing unit for sensing a displacement of the device in at least one dimension; a processor coupled with the sensing unit for receiving the displacement and then outputting a control signal; a medium unit coupled with the processor for reading or setting data; and a switch respectively coupled with the processor and the medium unit for receiving the control signal to turn on or off power supplied to the medium unit.

U.S. Pat. No. 5,982,573 discloses a disk drive having a fall detection control system that detects when a disk drive is in a free fall, and takes precautionary protective action to minimize physical damage from any resulting shock upon impact. The disk drive includes an accelerometer device that measures acceleration of the disk drive along three mutually orthogonal axes x, y, and z and resolves the measurement into respective x, y, and z vectors. In a method disclosed in the prior art, to minimize shock-induced damage of the disk drive, the acceleration of the falling disk drive is detected; the detected acceleration is compared with a selected acceleration threshold level; a duration that the detected acceleration exceeds the acceleration threshold level is measured; the measured duration is compared with a selected reference time period; and a warning signal is output when the measured duration exceeds the reference time period. Upon receipt of the warning signal, a controller initiates protective routines in preparation for shock.

U.S. Pat. No. 5,227,929 discloses a protective reflex system for a portable computer hard disk. The portable computer hard disk protective reflex system includes a three axis accelerometer, a dedicated processor, and a central processing unit of the portable computer. The accelerometer detects changes in the acceleration of the portable computer and generates a signal to the dedicated processor, informing the dedicated processor to tell the central processing unit of the portable computer to park the disk heads.

U.S. Pat. No. 5,235,472 discloses an apparatus for sensing operating shock on a disk drive. The apparatus comprises a piezoelectric polymer film, an amplifier and a comparator. The piezoelectric polymer film is encapsulated and electrically shielded by a metallic or metallic coated package, for sensing shock loads generated by or applied to the disk drive and generating a voltage to the amplifier for amplification and then to the comparator for comparison with a predetermined threshold voltage. The control circuit accordingly issues a write fault signal when the detected signal exceeds the predetermined threshold voltage, to stop writing of the read/write heads. The device may be mounted on the computer disk drive of the unit in such a manner as to be at a 45 degree angle to each of the x, y and z axis of the orthogonal coordinate system so that linear and torsional forces may be monitored.

U.S. Pat. No. 5,333,138 discloses an apparatus and method for preventing data corruption in disk drives from mechanical shock during write operations. The apparatus comprises includes a mechanical shock sensor to sense mechanical shocks having a magnitude exceeding a predetermined threshold. When a mechanical shock is detected, a write disable circuitry interrupts the write current to the disk drive write head. A repositioning circuitry then repositions the data head over the original data track and the incomplete data that was interrupted by the mechanical shock is rewritten. The method disclosed in the prior art includes the steps of sensing a mechanical shock having a magnitude exceeding a predetermined threshold; storing information identifying the data being written at the onset of the sensed shock; interrupting the write current to the write head; repositioning the data head to the original track; and rewriting the data which was interrupted because of the sensed shock.

The falling sensor in U.S. Pat. No. 6,771,449 includes a tubular conductive member, a flexible member arranged inside the tubular conductive member, and a weight arranged to an edge of the beam. The weight contacts the conductive member at the deflected state (the normal state) of the flexible member, and the weight comes out of contact with the conductive member during a falling of the magnetic disk drive. On detecting the falling state, the drive activates an evacuating operation to evacuate the magnetic head by the unload mechanism. Therefore, demolitions of the magnetic head and the magnetic disk by a crush between the magnetic head and the magnetic disk, which is caused by a shock at the end of falling, can be avoided.

An acceleration sensing device for protecting a hard disk drive unit of a portable computer is disclosed in U.S. Pat. No. 6,046,877. The acceleration sensing device senses the acceleration of a computer such that the computer is subject to zero support force (i.e., is in a free fall), and a control microprocessor of the disk drive unit determines that such state lasts for longer than a certain minimum of time. If the detected time exceeds the chosen time, the control microprocessor signals the removal of the heads from the disk to park the heads.

However, these prior art techniques are usually uneasy to effectuate; some of them necessitate modification of the internal structure of the hard disk, while others require a dedicated processor to achieve the protection of a falling portable computer hard disk. Moreover, these prior art techniques fail to provide a perfect system protection because they normally make use of only the functional mechanism of the hard disk, not the more powerful and complete computer system resources. In other words, in the event of a falling or impacted portable computer, these prior art techniques can only provide limited protection to the hard disk of the portable computer, without the ability of controlling the state of the whole portable computer and systematically providing a protection at the critical time.

Further, the prior art techniques do not include any design allowing the user to monitor the computer. Therefore, there is no way for a user to know whether the hard disk is parked or not.

### SUMMARY OF THE INVENTION

It is therefore a primary object of the present invention to provide a falling protective method for a hard disk of a portable computer, in which a software monitoring driver works in cooperation with the computer system resources for protecting the hard disk of the portable computer as soon as a falling or an impacted state of the computer is detected.

Another object of the present invention is to provide a falling protective method for a hard disk of a portable computer, in which the state of the hard disk of the portable computer is constantly polled. In the method, a falling sensor is used to detect if the portable computer falls and to responsively send an interrupt signal to a keyboard controller of the portable computer. A software monitoring driver keeps detecting a falling state signal at a default signal port of the keyboard controller. When a falling state is detected, the software monitoring driver immediately interrupts hard disk data access on the portable computer.

To fulfill the above object, a method of detecting and protecting a hard disk of a falling portable computer is provided. A falling sensor detects a falling state of a portable computer and triggers an interrupt signal to a keyboard controller of the computer, and a falling state signal is responded at a default signal port of the keyboard controller. A software monitoring driver executes polling via an I/O driver about the falling state signal at the default signal port of the keyboard controller, and determines based on the falling state signal whether to actuate a hard disk protection mechanism, in which the software monitoring driver interrupts hard disk data access on the computer via a hard disk driver, and causes a system BIOS of the computer to send a parking control signal to the hard disk.

By applying the method, a user is able to monitor the state of the hard disk and protect the disk hard from shock or impact. The user can set the reference acceleration value and various parameters, and trigger the execution or suspension of the detecting and protection method and other operations. Also, the user may determine to restore the operation of the hard disk or not.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a system block diagram, in which the method of the present invention is implemented;

FIG. 2 is a flowchart showing that a falling sensor detects a falling or an impacted portable computer and generates an interrupt signal; and

FIGS. 3A and 3B are flowcharts showing the control steps at the software monitoring driver end according to the method of the present invention.

### DETAILED DESCRIPTION OF THE PREFERRED EMBODIMENTS

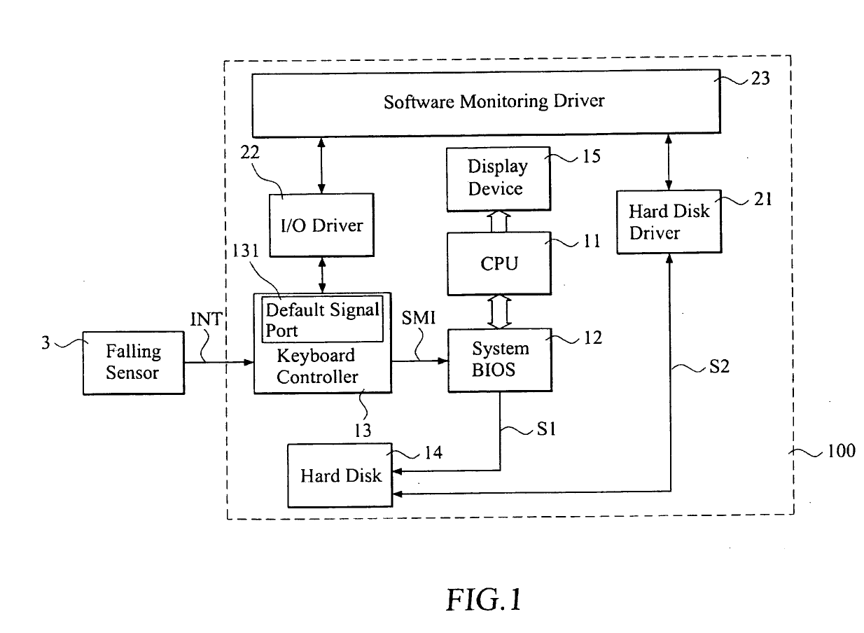

Please refer to FIG. 1 that is a system block diagram, in which a method of the present invention for detecting and protecting falling portable computer hard disk through software monitoring driver is implemented. As shown, in a simplified portable computer 100, there are included a central processing unit (CPU) 11, a system BIOS (Basic Input/Output System) 12, a keyboard controller 13, a hard disk (HD) 14, a display device 15, and other parts, such as system memory, bridge, bus, display interface, etc. Generally, a keyboard and a computer mouse are connected to the keyboard controller 13.

The keyboard controller 13 is connected to the portable computer 100 via a bus and a default data transmission port, and there is an SMI (system management interrupt) signal line connected between the keyboard controller 13 and the system BIOS 12. The keyboard controller 13 may send an SMI signal SMI to the system BIOS 12 via the SMI signal line.

The hard disk 14 is connected to the portable computer 100 via a bus, such as an IDE interface bus, and a default data transmission port; and the system BIOS 12 may send a parking signal S1 to the hard disk 14 via a signal line, so as to order the hard disk 14 to park or to un-park. The hard disk 14 is driven by a hard disk driver 21. Data on the hard disk 14 may be accessed via the hard disk driver 21 and a data transmission line S2.

The keyboard controller 13 is connected via a default signal port 131 to an input/output (I/O) driver 22. In the default signal port 131, there is included at least a default status bit standing for a state that an interrupt signal has been sent out by a falling sensor. In a typical portable computer currently available in the market, the default signal port 131 of the keyboard controller 13 may be signal port 6C, and the default status bit in the signal port 6C is bit 7. Via the I/O driver 22, a software monitoring driver 23 executes polling about the state of the default status bit in the default signal port 131 of the keyboard controller 13. The software monitoring driver 23 is set to the operating system (OS) level, and may be written using general program language and installed in the portable computer 100. Preferably, the software monitoring driver 23 is loaded and run as soon as the operating system of the portable computer is initialized and the drivers for all associated peripheral computer devices are enabled. Moreover, the software monitoring driver 23 is resided in the system memory of the portable computer 100.

A falling sensor 3 is connected to the keyboard controller 13 via a signal line. When the falling sensor 3 senses a falling or an impacted state of the portable computer 100, that is, when the falling sensor 3 detects an acceleration signal that exceeds a preset acceleration signal level, an interrupt signal INT is triggered by the falling sensor 3 to the keyboard controller 13. A reasonable acceleration range may be set through the keyboard controller 13 and used by the falling sensor 3 as the preset acceleration signal level for determining whether a falling state exists or not.

In a preferred embodiment of the present invention, the falling sensor 3 may be an accelerometer, and preferably, a three axis accelerometer, for detecting acceleration signals in three axis directions and determining whether any one of the detected acceleration signals exceeds the preset acceleration signal level, so as to send out an interrupt signal INT to the keyboard controller 13 when it is determined the detected acceleration signal exceeds the preset acceleration signal level.

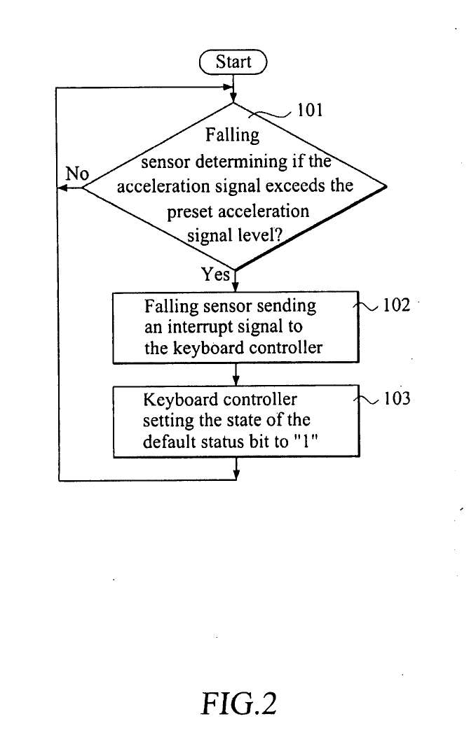

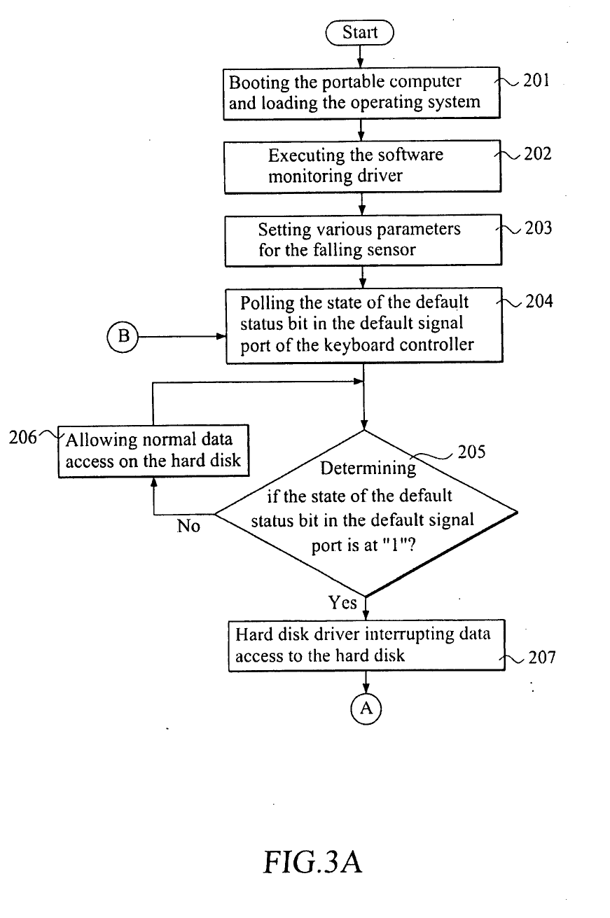

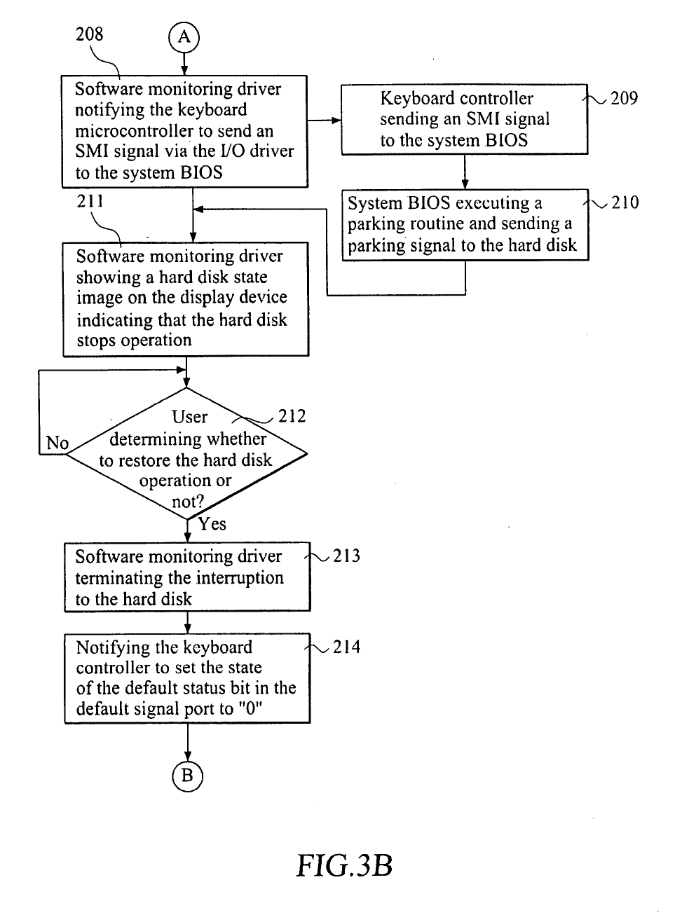

FIG. 2 is a flowchart showing that the falling sensor 3 detects a falling or an impacted portable computer and generates an interrupt signal; and FIGS. 3A and 3B are flowcharts showing the control steps at the software monitoring driver of the computer according to the method of the present invention. The present invention will now be described in more details with reference to FIGS. 1, 2, 3A, and 3B at the same time.

Please refer to FIG. 2. In the event the booted portable computer 100 is subjected to a falling or an impacted state, the falling sensor 3 would immediately sense the falling or impacted state. When the falling sensor 3 detects an acceleration signal exceeding the preset acceleration signal level (step 101), an interrupt signal INT is sent by the falling sensor 3 to the keyboard controller 13 (step 102). On receipt of the interrupt signal INT generated by the falling sensor 3, the keyboard controller 13 sets the state of the default status bit (bit 7) in the default signal port 131 (i.e. port 6C) to “1” (step 103). In the illustrated embodiment, the keyboard controller 13 uses the default status bit (bit 7) in the default signal port 131 to record the state signal and respond to the falling or impacted state of the portable computer 100. However, it is understood many other ways, such as a preset flag or a register state, may also be used to record the state and respond to a falling portable computer.

Meanwhile, as shown in FIG. 3A, when the portable computer 100 is booted and the operating system thereof is loaded (step 201), the software monitoring driver 23 also starts execution (step 202). Then, the software monitoring driver 23 notifies the keyboard controller 13 via the I/O driver 22 connected to the keyboard controller 13 that the software monitoring driver 23 is in normal execution.

When necessary, a user may use the software monitoring driver 23 to set various user-defined parameters for the falling sensor 3 via the I/O driver 22 and the keyboard controller 13 (step 203). In the step 203, the falling sensor 3 is initialized via the keyboard controller 13, and a reference value is set to the falling sensor 3 as the preset acceleration signal level for determining whether there is a falling state.

Then, the software monitoring driver 23 starts polling about the state of the default status bit in the default signal port 131 (i.e. port 6C) of the keyboard controller 13 via the I/O driver 22 (step 204). At this point, if the default status bit in the default signal port 131 is at the low level signal state of “0”, or a first state, it indicates the portable computer currently allows normal data access to the hard disk 14. That is, data on the hard disk 14 could be accessed normally via the hard disk driver 21 and the data transmission line S2 (step 206).

However, in step 205, if the default status bit in the default signal port 131 is at the high level signal state of “1”, or a second state, the software monitoring driver 23 interrupts via the hard disk driver 21 the hard disk data access on the portable computer 100 (step 207). In other words, a hard disk protection mechanism of the hard disk driver 21 is enabled at this point.

Please refer to FIG. 3B. When the protection mechanism of the hard disk driver 21 is enabled, the keyboard controller 13 is notified by the software monitoring driver 23 via the I/O driver 22 to send an SMI signal to the system BIOS 12 (step 208). At this point, the keyboard controller 13 sends an SMI signal SMI to the system BIOS 12, accordingly (step 209).

On receipt of the SMI signal SMI generated by the keyboard controller 13, the system BIOS 12 immediately executes a parking routine, and sends a parking signal to the hard disk 14 (step 210). Subsequently, the hard disk 14 moves read-write heads thereof away from platters of the hard disk 14, so as to protect the hard disk 14 against damage.

In step 208, when the software monitoring driver 23 informs the keyboard controller 13 to send an SMI signal to the system BIOS 12, a hard disk state image is shown on the display device 15 by the software monitoring driver 23 at the same time to indicate the hard disk 14 has stopped operation (step 211), so that a user knows the current state of the hard disk 14, and may determine whether to restore the hard disk operation or not (step 212).

When the user determines to restore the operation of the hard disk 14, the software monitoring driver 23 terminates the interruption to the hard disk 14 (step 213). That is, the data on the hard disk 14 is accessible again. Meanwhile, the keyboard controller 13 is informed by the software monitoring driver 23 via the I/O driver 22 to set the state of the default status bit in the default signal port (i.e. port 6C) to “0” (step 214). Then, the procedure goes back to the step 204 to keep detecting any other falling or impacted state of the portable computer 100.

In the step 205 of the above described method, when it is detected the default status bit in the default signal port 131 is in the high level signal state of “1”, or a second state, the software monitoring driver 23 not only interrupts via the hard disk driver 21 the access to the data on the hard disk 14 (that is, step 207), but also executes the hard disk parking routine (that is, steps 208 to 210). However, it allows the software monitoring driver 23 to only interrupt via the hard disk driver 21 the access to the data on the hard disk 14 (that is, step 207), while the hard disk parking routine (that is, steps 208 to 210) is selectively executed. Alternatively, the software monitoring driver 23 may only execute the hard disk parking routine (that is, steps 208 to 210) while the interruption of hard disk data access via the hard disk driver 21 (that is, step 207) is selectively executed. In either way, the hard disk of the falling portable computer is protected against damage.

Moreover, the present invention may be differently designed to either allow the user to manually restore the hard disk operation (steps 212 to 214), or simply allow the computer to automatically restore the hard disk operation, when the software monitoring driver 23 shows the hard disk state image on the display device 15 indicates that the hard disk has stopped operating (step 211). As it can be understood by those skilled in the art, the design allowing automatic restoration of the hard disk operation can still be carried out without departing from the scope and the spirit of the invention defined by the appended claims. In other words, when it is detected the portable computer 100 is no longer in the falling state, that is, the default status bit in the default signal port 131 of the keyboard controller 13 becomes “0”, the software monitoring driver 23 may automatically restore the hard disk data access via the hard disk driver 21 and an un-parking signal may be automatically sent out.

What is claimed is:

1. A method of detecting and protecting falling portable computer hard disk, the portable computer including a CPU, a system BIOS, a keyboard controller, a display device, and a falling sensor; the falling sensor being electrically connected to the keyboard controller for detecting a falling state of the portable computer and sending an interrupt signal to the keyboard controller in response to the detected falling state, so that a falling state signal is responded at a default signal port of the keyboard controller, the method comprising the following steps:
(a) loading an operating system on the portable computer and starting executing a software monitoring driver;
(b) the software monitoring driver executing polling via an I/O driver about the falling state signal at the default signal port of the keyboard controller; and
(c) normal hard disk data access on the portable computer being allowed when the falling state signal at the default signal port of the keyboard controller is in a first state; or hard disk data access on the portable computer being interrupted by the software monitoring driver via a hard disk driver when the falling state signal at the default signal port of the keyboard controller is in a second state.

2. The method of detecting and protecting falling portable computer hard disk as claimed in claim 1, wherein, in the step (b), the falling state signal is recorded at a default status bit in the default signal port of the keyboard controller.

3. The method of detecting and protecting falling portable computer hard disk as claimed in claim 1, further comprising the following steps after the step (c):
(d) the software monitoring driver notifying the keyboard controller via the I/O driver to send an SMI signal to the system BIOS;
(e) the keyboard controller sending an SMI signal to the system BIOS; and
(f) on receipt of the SMI signal generated by the keyboard controller, the system BIOS executing a parking routine, and sending a hard disk parking signal to the hard disk.

4. The method of detecting and protecting falling portable computer hard disk as claimed in claim 1, further comprising the following step after the step (c): showing a hard disk state image on the display device to indicate a current state of the hard disk.

5. The method of detecting and protecting falling portable computer hard disk as claimed in claim 4, further comprising the following step after the step of showing a hard disk state image on the display device: allowing a user to determine whether to restore the hard disk operation.

6. The method of detecting and protecting falling portable computer hard disk as claimed in claim 5, wherein the step of allowing a user to determine whether to restore the hard disk operation further includes the step of: the software monitoring driver restoring the hard disk data access on the portable computer when the user determines to restore the hard disk operation, and notifying the keyboard controller via the I/O driver to set the falling state signal from the second state to the first state.

7. A method of detecting and protecting falling portable computer hard disk, the portable computer including a CPU, a system BIOS, a keyboard controller, a display device, and a falling sensor; the falling sensor being electrically connected to the keyboard controller for detecting a falling state of the portable computer and sending an interrupt signal to the keyboard controller in response to the detected falling state, so that a falling state signal is responded at a default signal port of the keyboard controller; the method comprising the following steps:
(a) loading an operating system on the portable computer and starting running a software monitoring driver;
(b) the software monitoring driver executing polling via an I/O driver about the falling state signal at the default signal port of the keyboard controller;
(c) normal hard disk data access on the portable computer being allowed when the falling state signal at the default signal port of the keyboard controller is in a first state; or the software monitoring driver notifying the keyboard controller via the I/O driver to send an SMI signal to the system BIOS when the falling state signal at the default signal port of the keyboard controller is in a second state;
(d) the keyboard controller sending an SMI signal to the system BIOS; and;
(e) on receipt of the SMI signal generated by the keyboard controller, the system BIOS executing a parking routine and sending a hard disk parking signal to the hard disk.

8. The method of detecting and protecting falling portable computer hard disk as claimed in claim 7, wherein, in the step (b), the falling state signal is recorded at a default status bit in the default signal port of the keyboard controller.

9. The method of detecting and protecting falling portable computer hard disk through software monitoring driver as claimed in claim 7, further comprising the following step after the step (c): showing a hard disk state image on the display device to indicate a current state of the hard disk.

10. The method of detecting and protecting falling portable computer hard disk as claimed in claim 9, further comprising the following step after the step of showing a hard disk state image on the display device: allowing a user to determine whether to restore the hard disk operation.

11. The method of detecting and protecting falling portable computer hard disk as claimed in claim 10, wherein the step of allowing a user to determine whether to restore the hard disk operation further includes the step of: the software monitoring driver restoring the hard disk data access on the portable computer when the user determines to restore the hard disk operation, and notifying the keyboard controller via the I/O driver to set the falling state signal from the second state to the first state.
